(19) United States
(12) Patent Application Publication
(10) Pub. No.: US 2013/0340333 A1
(43) Pub. Date: Dec. 26, 2013

(54) PRODUCT INTENDED TO BE ADDED TO CROP IRRIGATION WATER

(71) Applicants: Loic Vialatte, Lyon (FR); Bernard Sabatier, Perigneux (FR)

(72) Inventors: Loic Vialatte, Lyon (FR); Bernard Sabatier, Perigneux (FR)

(73) Assignee: S.P.C.M. SA, ANDREZIEUX-BOUTHEON (FR)

(21) Appl. No.: 14/002,757

(22) PCT Filed: Mar. 2, 2012
(86) PCT No.: PCT/FR12/50443

§ 371 Date: Sep. 3, 2013

(30) Foreign Application Priority Data
Mar. 3, 2011 (FR) 11 51743

(51) Int. Cl. A01G 1/00

(52) U.S. Cl. CPC A01G 1/001
USPC 47/58.1 R; 524/321; 524/42; 428/35.2

(57) ABSTRACT

The present invention relates to a product intended to be added to crop or plantation irrigation water, comprising a composition containing one or more water-soluble polymers and an effervescent system, wherein the composition is in the form of a powder, and in particular a powder of individualized particles, said composition being confined in a water-soluble film.

The present invention relates to the technical field of irrigation in agriculture. More specifically, the subject of the present invention is a composition in the form of a powder comprising at least one water-soluble polymer and an effervescent system, packaged in a water-soluble film forming a bag. This packaging associated with said composition makes it possible to obtain rapid and complete dissolution of the polymer while at the same time dispensing with a stirring step.

Irrigation is a technique well known to those skilled in the art. It consists in providing crops with water artificially. It is used, inter alia, for crops which consume large amounts of water (for example: corn, cotton, etc.) or else in a region with a low rainfall, in order to meet the needs of the plant.

There are various types of irrigation system which can be classified into two categories:
gravity systems: the most widely known is basin irrigation where the water is provided in the form of a layer in a basin laid out on a leveled soil (0.1-1% slope). Mention may also be made of furrow irrigation where the water is provided by flowing in separate furrows.
Pressurized systems: with irrigation by spraying, the water is distributed in the form of rain with regulation and uniformity. These systems may be fixed or mobile. Mention may also be made of localized “drip” irrigation, where the water circulates in flexible pipes of small diameter, placed at the surface of the soil, in the subsoil or buried. These pipes are equipped with “drip” devices which provide the water in proximity to the roots.

Over the past 50 years, organic polymers such as polyacrylamides have been greatly used to stabilize soils, to control erosion and/or to improve water and nutrient retention.

Indeed, in 1986, Wallace discovered that the use of polymers on fields enabled stabilization of the soil (Effects of excess levels of a polymer as a soil conditioner on yields and mineral nutrition plants—Soil Science 141, 377-380). Aase, for his part, demonstrated in 1998 that polyacrylamide reduced water loss and erosion which are due to the irrigation system (Sprinkler irrigation runoff and erosion control with polyacrylamide—laboratory tests—Soil Science Society of America journal 62, 1681-1686). Finally, more recently, Phillips, in 2007, noted that the application of polymer at low concentration had a significant effect on the reduction of water infiltrations for light textured soils (Impact of PAM on the hydrological properties of some light textured soils. Thesis for Masters of Applied Science, Adelaide University 2007). Documents EP 0 415 141, U.S. Pat. No. 5,405,425 and WO 01/82 869 describe formulation of hydrosoluble polymers particularly adapted for soils treatment in agriculture.

Water-soluble polymers are sold, for their applications in agriculture, for the purpose of stabilizing soils and limiting erosion, in various forms:
the powder form which is not very practical for handling since it creates the formation of dust which is dangerous for the user. Furthermore, this form requires a mixing apparatus and a considerable dissolution time. When the dissolution is poorly carried out, it generates lumps that can subsequently block the pipes during irrigation,
the invert emulsion which overcomes some of the problems mentioned above. However, it requires a dissolution phase in order to invert the emulsion. Thus, this form requires the use of a metering pump, in order to have a precise dosage, which is not very convenient. Furthermore, the presence of oil can pose a problem since it is sometimes prohibited for environmental reasons,
the tablet or pellet form which facilitates metering, but the dissolution of which is very slow (often more than one hour) and incomplete. In addition, because of aging, the tablets have a tendency to harden and to generate insoluble material at the time of use.

The application WO 97/03 111 describes a composition in form of granules which presents the same disadvantages than compositions in tablet or pellet form. In this context, the present invention proposes to provide a novel formulation of water-soluble polymers which makes it possible to overcome the problems mentioned above.

The invention consists of a product intended to be added to crop or plantation irrigation water, comprising a composition containing one or more water-soluble polymers and an effervescent system, wherein the composition is in the form of a powder, and in particular of a powder of individualized particles, said composition being confined in a water-soluble film. This water-soluble film, once immersed in water, dissolves and thus makes it possible to gradually bring the polymeric composition into contact with the water, which will facilitate the diffusion and the dissolution of the polymer(s) in the water.

The presentation form of the composition in accordance with the invention is suitable for uses in the agricultural field and makes it possible to dispense with a stirring step, to facilitate the metering, and to improve the dissolution time, while at the same time avoiding direct contact with the powder by the user.

The subject of the present invention is also a crop irrigation process in which the crops are irrigated with water in which a product according to the invention has been dissolved. According to one advantageous embodiment, the product is dissolved in the irrigation water, in the absence of stirring. In the context of the invention, the irrigation can be carried out by means of a gravity irrigation device or a pressurized irrigation device.

According to one particular embodiment, the composition present in the product according to the invention also contains an anti-packing agent and/or inorganic fillers.

The expression “water-soluble compound (polymer or film)” is intended to mean generally a compound which can dissolve or disperse in water in the form of a molecular solution at ambient temperature (25° C.), in particular when it is introduced in a proportion of 0.1% by weight in water.

The water-soluble polymer(s) of the invention is (are) preferably copolymers composed of various monomers, and in particular:
from 1 to 99 mol % of at least one anionic monomer. The anionic monomers which can be used in the present invention can be chosen from a broad group. These monomers can have acrylic, vinyl, maleic, fumaric and allyl functions and can contain a carboxy, phosphonate or sulfonate group, or another group with an anionic charge, or else the corresponding ammonium or alkaline earth metal or alkali metal salt. Examples of suitable monomers include acrylic acid, methacrylic acid, itaconic acid, crotonic acid, maleic acid, fumaric acid and monomers of strong acid type having, for example, a function of sulfonic acid or phosphonic acid type, such as 2-acrylamido-2-methylpropanesulfonic acid, vinylsulfonic acid, vinylphosphonic acid, allylsulfonic acid, allylphosphonic acid, styrenesulfonic acid and their water-soluble salts of an alkali metal, of an alkaline earth metal or of ammonium, and
from 1 to 99 mol % of at least one nonionic monomer. The nonionic monomers which can be used in the context of the invention can be chosen, in particular, from the group comprising water-soluble vinyl monomers. Preferred monomers belonging to this class are, for example, acrylamide and methacrylamide, N-isopropylacrylamide, N,N-dimethylacrylamide and N-methylolacrylamide. N-vinylformamide, N-vinylacetamide, N-vinylpyridine and N-vinylpyrrolidone can also be used. A preferred nonionic monomer is acrylamide.

According to certain embodiments, in addition to the monomers above, the water-soluble polymer(s) can also comprise:
one or more cationic monomers of acrylamide, acrylic, vinyl, allyl or maleic type having a quaternary ammonium or amine function. Mention may in particular, and in a nonlimiting manner, be made of dimethylaminoethyl acrylate (ADAME) and dimethylaminoethyl methacrylate (MADAME) which are quaternized or salified, dimethyldiallylammonium chloride (DADMAC), acrylamidopropyltrimethylammonium chloride (APTAC) and methacrylamidopropyltrimethylammonium chloride (MAPTAC). The zwitterionic monomers prepared from the cationic and anionic groups below can also be used in the context of the invention, and/or
one or more hydrophobic monomers of acrylamide, acrylic, vinyl, allyl or maleic type having a side hydrophobic function, preferentially chosen from acrylamide derivatives, for instance N-alkylacrylamides, for example, diacetoneacrylamide, isopropylacylamide, N-tert-butylacrylamide and octylacrylamide, and N,N-dialkylacrylamides, for instance N,N-dihexylacrylamide and N,N-dimethylacrylamide, and acrylic acid derivatives, for instance alkyl acrylates and methacrylates. Vinyl monomers such as N-vinylformamide, N-vinylacetamide, N-vinylpyridine and N-vinylimidazole can also be used.

The polymers used in the context of the invention do not require any particular polymerization process development. They can be obtained by any of the polymerization techniques well known by those skilled in the art (solution polymerization, gel polymerization, precipitation polymerization, (aqueous or inverse) emulsion polymerization followed by a spray drying step, suspension polymerization, micellar polymerization followed by a precipitation step), as described in Synthetic polyelectrolytes—a review—David A Mortimer—Polymer international 25 (1991) 29-41.

The ionicity of the water-soluble polymer(s) present in the composition is preferably from 1 to 50 mol % anionic and preferentially from 10 to 30 mol % anionic. The molecular weight of the water-soluble polymer(s) present in the composition is generally greater than 1 million g/mol.

The water-soluble polymer(s) preferably represent(s) from 1 to 50%, preferentially from 4.5 to 40% and more preferentially from 9 to 20% by weight of the total weight of the composition.

The effervescent system can be in the form of a single compound, but it will most commonly consist of a pairing of compounds. Such an effervescent pairing typically comprises one or more acid compounds and an alkali metal compound. The acid compound(s) can, in a nonlimiting manner, be chosen from citric acid, tartaric acid, adipic acid, fumaric acid and maleic acid, and salts thereof. The alkali metal compound can, in a nonlimiting manner, be chosen from sodium carbonates and bicarbonates, calcium carbonates and bicarbonates and potassium carbonates and bicarbonates. Preferably, the effervescent system will consist of citric acid, adipic acid and sodium bicarbonate.

The weight ratio of the acid compound(s) to the alkali metal compound is, for example, within the range from 1:99 to 99:1, preferably within the range of from 1:10 to 10:1, and is in particular equal to 1:1.

The effervescent system, and in particular the acid(s)/alkali metal compound effervescent pairing previously described, preferably represents from 1 to 50%, preferentially from 5 to 30% and more preferentially from 20 to 25% by weight of the total weight of the composition.

The anti-packing agent, when it is present, can, for example, be chosen from the following nonexhaustive list: carboxymethylcellulose (CMC), sodium carbonate, potassium carbonate, ammonium carbonate, ammonium bicarbonate, sodium ferrocyanide, potassium ferrocyanide, calcium ferrocyanide and zinc silicate.

Carboxymethylcellulose will preferably be used. The presence of such an anti-packing agent will in particular promote the nonagglomeration of the powder inside the packaging formed by the film, which is most commonly in the form of a bag.

The anti-packing agent preferably represents from 0 to 10%, preferentially from 0.5 to 5% and more preferentially from 1 to 2% by weight of the total weight of the composition.

The inorganic filler(s) when it (they) is (are) present, is (are) selected, in a nonlimiting manner, from alkali metal sulfate or chloride salts. Sodium sulfate will preferably be chosen.

The inorganic fillers preferably represent from 0 to 98%, preferably from 10 to 90% and more preferentially from 20 to 70% by weight of the total weight of the composition.

The composition may optionally contain other compounds commonly used in agriculture, for instance trace elements such as boron, copper, iron, manganese, molybdenum and/or zinc; fertilizers such as ammonium nitrates, urea, ammonium sulfate, potassium nitrate, ammonia, potassium sulfate and/or phosphates acidulated with sulfuric acid, calcium phosphates, dicalcium phosphates, ammonium phosphates or alumino-calcium phosphates.

The composition may also, optionally, contain one or more dyes.

Of course, the amounts of the various constituents present in the composition are chosen in such a way that the sum of the proportions of all the constituents present is equal to 100%. According to one particular embodiment which can be combined with the previous ones, the total weight of the water-soluble polymer(s) present, of the effervescent system, of the anti-packing agent and of the inorganic fillers represents from 90% to 100% of the total weight of the composition and preferably from 95 to 99% of the total weight of the composition.

According to one particular embodiment, the composition therefore comprises:
from 1 to 50% by weight of water-soluble polymer(s),
from 1 to 50% by weight of an effervescent system,
from 0 to 10% by weight of anti-packing agent, and
from 0 to 98% of inorganic fillers.

According to one preferred embodiment, the composition comprises:
from 4.5 to 40% by weight of water-soluble polymer(s),
from 5 to 30% by weight of an effervescent system,
from 0.5 to 5% by weight of anti-packing agent, and
from 10 to 90% of inorganic fillers.

According to one even more preferred embodiment, the composition comprises:
from 9 to 20% by weight of water-soluble polymer(s),
from 20 to 25% by weight of an effervescent system,
from 1 to 2% by weight of anti-packing agent, and
from 20 to 70% of inorganic fillers.

In particular, the compositions present in the product according to the invention comprise, in addition to the water-soluble polymer(s), preferably based on acrylamide, a mixture of citric acid, adipic acid and sodium bicarbonate, as effervescent system, carboxymethylcellulose as anti-packing agent and sodium sulfate as inorganic filler.

The composition is in the form of a powder, or more specifically of a mixture of powders, each of the constituents being in the form of a powder. The particles present in the powder are said to be individualized, because they are not aggregated with one another so as to form a single solid form. This makes it possible to promote, in combination with the presence of the effervescent system, their dissolution in water, once the barrier of the water-soluble film has disappeared. The powder can also be described as non-agglomerated, i.e. the particles are not aggregated with one another so as to form a single assembly of the tablet or pellet type. Nevertheless, it is not excluded that, locally, the powder comprises particle aggregations. The size of the particles of the composition is preferably less than 1 millimeter, preferably less than 500 micrometers. Preferentially, the size of the particles of the polymer(s) is less than 300 micrometers. In the context of the invention, the size of the particles can be defined by the volume average size, which can, for example, be determined using the Mastersizer 2000 instrument from the company Malvern with a mathematical model based on the Mie scattering theory.

The various powders constituting the composition may be mixed according to any known techniques to obtain a homogeneous mixture.

This powder is confined in a water-soluble film forming a bag. The water-soluble film, for its part, can be composed of one or more layers. The layer(s) can, for example, be composed of polyvinyl alcohol, of polyoxyethylene, of cellulose derivatives such as methylcellulose, methylhydroxyethylcellulose, methylhydroxypropylcellulose, hydroxypropylcellulose, cellulose acetate and cellulose derivatives modified so as to be hydrophobic, or of a compound chosen from sodium polyacrylate, polylactic acid, lactic acid ethers, polyvinyl alcohol esters, lactic acid ethers, cellulose derivative esters, lactic acid grafted onto polyvinyl alcohol, carrageenan and pectin, or of a combination of several of the compounds mentioned above or of a mixture of one or more of these compounds with modified or unmodified starch (corn starch, potato starch, rice starch and wheat starch). Preferably, the water-soluble film will be a monolayer film and composed of polyvinyl alcohol. For the production of such films, reference may in particular be made to Kirk-Othmer—Encyclopedia of chemical technology 5^{th} edition—Vinyl alcohol polymer—F. L. Martens p 591-p 627.

The water-soluble film can be produced according to the casting or extrusion method. A bag can be obtained by welding on two sides, “3-sided welding” or 4-sided welding so as to form a “cushion”, in particular. The bag preferably has a generally rectangular shape with dimensions L×1×h, with L, for example, being within the range of from 4.5 to 7 cm, 1 within the range of from 2.5 to 4 cm, and h within the range of 1.5 to 0.8 cm.

The thickness of the film is, for example, within the range of from 10 to 500 micrometers or more, preferably within the range of from 20 to 75 micrometers.

The film constitutes a shell around the composition in powder form and forms a packaging which is degradable in water, of the bag type. This unit packaging of the bag type can, for example, contain from 5 to 100 g of composition, preferably from 10 to 50 g.

When the product according to the invention, of the bag type, containing the composition is placed in water, the water-soluble film dissolves and disperses in the water so as to release the polymer-based composition. The dissolution time of the composition is dependent, in particular, on the size of the particles, on the proportion of the various components and on the thickness of the film. Advantageously, the dissolution time of the composition, once the product has been placed in 1 m³ of water at 20° C., is 2 minutes for a 50 g bag comprising 20% of polymer.

The examples below make it possible to illustrate the invention but are in no way limiting in nature.

### EXAMPLES

### Example 1

### Irrigation with a Pressurized System

The use of a water-soluble polymer was implemented for the purpose of improving the spraying of liquid fertilizer onto the vine.

An acrylamide/sodium acrylate (70/30) copolymer with a molecular weight of 10 million g/mol was prepared in the form of a powder in a water-soluble bag of 50 g in accordance with the invention. The powder is composed of 10% of polymer, 25% of an effervescent system, 2% of carboxymethylcellulose with the rest made up with sodium sulfate. The effervescent system is composed of 25% of citric acid, 25% of adipic acid and 50% of sodium bicarbonate. This composition packaged in a water-soluble film, which is composed of polyvinyl alcohol, is introduced into the tank of a spray containing the mixture (mixture of water and liquid fertilizer). Without stirring, the composition takes less than two minutes to dissolve.

By way of comparison, an effervescent tablet of 50 g containing 10% of the same copolymer is also introduced into the tank of a spray containing the mixture (mixture of water and liquid fertilizer). In this system, the stirring is carried out with water recirculation in the tank. Despite this stirring, the tablet requires 45 minutes to dissolve.

During the spraying of the solution using the tablet, some nozzles become blocked. After examination of the nozzles, small blocks originating from the tablet are found. Their origin may be due to poor dissolution of the tablet despite the time and stirring devoted thereto.

This problem is not found in the solution using the water-soluble bag. The spraying using this form operates perfectly.

### Example 2

### Irrigation with a Pressurized System

In this example, an acrylamide/sodium acrylate (80/20) copolymer with a molecular weight of 10 million g/mol was tested in the form of a powder in a water-soluble bag of 50 g in accordance with the invention. The composition of the powder and the film are identical to those of example 1. The use of this bag was compared with a commercial product (SoilPAM 135 from Ciba) which comprises an equivalent polymer and which is in the form of an invert emulsion.

These two forms are evaluated with a fertigation tank during the watering and fertilization of onions.

For the form as an invert emulsion, the emulsion requires the presence of stirring, provided by a blender, for 10 minutes at 500 rpm. This apparatus therefore involves the need for electricity. After the inversion of the emulsion and the dissolution of the polymer in 200 liters of water, an amount of microelements is added and the tank (of 1 m³) is filled with water.

For the form according to the invention, an amount of polymer equivalent to the form as an invert emulsion is introduced in a water-soluble bag. No stirring is then required during the dissolution of the polymer.

Just as previously, the same amount of microelements is introduced and the tank is filled up with water.

On three fields with identical characteristics, the irrigation is initiated with each of the two forms and a control which does not contain polymer, in order to obtain a constantly wet surface soil. The considerable evaporation requires a large amount of mixture, and 6 hours of irrigation are necessary for the two forms and 9 hours for the control.

At the end of the season, the onions are harvested and it is observed that the harvests from the fields irrigated with a polymer are comparable and much better than the control.

The test clearly shows that the performance levels of the polymer are not affected by the form in a water-soluble bag, this being without stirring.

### Example 3

### Irrigation with a Gravity System

A plot recently planted with young eucalyptus plants requires twice-monthly irrigation during the dry season. Since the plot is a long way from a water source, barrels which can be filled with water are placed in front of each row of plants in order to irrigate them. The barrels are filled by a tanker lorry. Because of the difficult conditions, the emulsion form cannot be used.

Half of the barrels (control) are filled only with water. The other half are filled with water to which water-soluble bags are added, so as to obtain a polymer concentration of 5 ppm per barrel.

For the control rows, an amount equivalent to 5 liters of water per plant is required, while 2 liters per plant are required when the water contains polymer.

At the end of the season, the mortality rate for the plants having been treated with the polymer is very much lower compared with the control.

In spite of difficult conditions of water availability and without mixing equipment, the bag form allows the use of polymer for the irrigation.

1. A product intended to be added to crop or plantation irrigation water, comprising a composition containing one or more water-soluble polymers and an effervescent system, wherein the composition is in the form of a powder and is confined in a water-soluble film.

2. The product as claimed in claim 1, wherein the powder is a powder of individualized particles.

3. The product as claimed in claim 1, wherein the size of the particles of the composition is preferably less than 1 millimeter

4. The product as claimed in claim 1, wherein the dissolution time of the composition, once the product has been placed in 1 m³ of water, at 20° C., is 2 minutes for a product of 50 g comprising 20% of polymer.

5. The product as claimed in claim 1, wherein the effervescent system corresponds to one or more acid compounds and an alkali metal compound.

6. The product as claimed in claim 4, wherein the effervescent system corresponds to one or more acid compounds chosen from citric acid, tartaric acid, adipic acid, fumaric acid and maleic acid, and salts thereof, and an alkali metal compound chosen from sodium carbonates and bicarbonates, calcium carbonates and bicarbonates and potassium carbonates and bicarbonates.

7. The product as claimed in claim 1, wherein the effervescent system represents from 1 to 50%, preferentially from 5 to 30% and more preferentially from 20 to 25% by weight of the total weight of the composition.

8. The product as claimed in claim 1, wherein the composition also contains an anti-packing agent and/or inorganic fillers.

9. The product as claimed in claim 7, wherein the composition contains an anti-packing agent chosen from the following list: carboxymethylcellulose (CMC), sodium carbonate, potassium carbonate, ammonium carbonate, ammonium bicarbonate, sodium ferrocyanide, potassium ferrocyanide, calcium ferrocyanide and zinc silicate.

10. The product as claimed in claim 8, wherein the composition contains an anti-packing agent and wherein the anti-packing agent represents from 0 to 10%, preferentially from 0.5 to 5% and more preferentially from 1 to 2% by weight of the total weight of the composition.

11. The product as claimed in claim 8, wherein the composition contains one or more inorganic fillers chosen from alkali metal sulfate or chloride salts.

12. The product as claimed in claim 8, wherein the composition contains one or more inorganic fillers and wherein the inorganic fillers preferably represent from 0 to 98%, preferably from 10 to 90% and more preferentially from 20 to 70% by weight of the total weight of the composition.

13. The product as claimed in claim 1, wherein the water-soluble polymer(s) is (are) copolymers composed of:
1 to 99 mol % of at least one anionic monomer, in particular, chosen from acrylic acid, methacrylic acid, itaconic acid, crotonic acid, maleic acid, fumaric acid and monomers of strong acid type having, for example, a function of sulfonic acid or phosphonic acid type, such as 2-acrylamido-2-methylpropanesulfonic acid, vinylsulfonic acid, vinylphosphonic acid, allylsulfonic acid, allylphosphonic acid, styrenesulfonic acid and their water-soluble salts of an alkali metal, of an alkaline earth metal or of ammonium, and
1 to 99 mol % of at least one nonionic monomer, in particular, chosen from acrylamide, methacrylamide, N-isopropylacrylamide, N,N-dimethylacrylamide, N-methylolacrylamide, N-vinylformamide, N-vinylacetamide, N-vinylpyridine and N-vinylpyrrolidone.

14. The product as claimed in claim 1, wherein the water-soluble polymer(s) also comprise(s):
one or more cationic monomers of acrylamide, acrylic, vinyl, allyl or maleic type having a quaternary ammonium or amine function, in particular chosen from dimethylaminoethyl acrylate (ADAME), dimethylaminoethyl methacrylate (MADAME) which are quaternized or salified, dimethyldiallylammonium chloride (DADMAC), acrylamidopropyltrimethylammonium chloride (APTAC) and methacrylamidopropyltrimethylammonium chloride (MAPTAC), and/or
one or more hydrophobic monomers of acrylamide, acrylic, vinyl, allyl or maleic type having a side hydrophobic function, particularly chosen from acrylamide derivatives, for instance N-alkylacrylamides, for example, diacetoneacrylamide, isopropylacylamide, N-tert-butylacrylamide and octylacrylamide, and N,N-dialkylacrylamides, for instance N,N-dihexylacrylamide and N,N-dimethylacrylamide, and acrylic acid derivatives, for instance alkyl acrylates and methacrylates, and vinyl monomers such as N-vinylformamide, N-vinylacetamide, N-vinylpyridine and N-vinylimidazole.

15. The product as claimed in claim 1, wherein the ionicity of the water-soluble polymer(s) present in the composition is from 1 to 50 mol % anionic and preferentially from 10 to 30 mol % anionic.

16. The product as claimed in claim 1, wherein the water-soluble polymer(s) represent(s) from 1 to 50%, preferentially from 4.5 to 40% and more preferentially from 9 to 20% by weight of the total weight of the composition.

17. The product as claimed in claim 1, wherein the film is composed of one or more layers, each of the layers being composed of polyvinyl alcohol, of polyoxyethylene, of cellulose derivatives such as methylcellulose, methylhydroxyethylcellulose, methylhydroxypropylcellulose, hydroxypropylcellulose, cellulose acetate and cellulose derivatives modified so as to be hydrophobic, or of a compound chosen from sodium polyacrylate, polylactic acid, lactic acid ethers, polyvinyl alcohol esters, lactic acid ethers, cellulose derivative esters, lactic acid grafted onto polyvinyl alcohol, carrageenan and pectin, or of a combination of several of the compounds mentioned above or of a mixture of one or more of these compounds with modified or unmodified starch, such as corn starch, potato starch, rice starch and wheat starch.

18. The product as claimed in claim 1, wherein the composition also comprises water-soluble polymer(s), preferably based on acrylamide, a mixture of citric acid, adipic acid and sodium carbonate, as effervescent system, carboxymethylcellulose as anti-packing agent and sodium sulfate as inorganic filler.

19. The product as claimed in claim 1, which is in the form of a bag.

20. A crop or plantation irrigation process in which the crops or plantations are irrigated with water in which a product as claimed in claim 1 has been dissolved.

21. The process as claimed in claim 20, wherein the product is dissolved in the irrigation water, in the absence of stirring.

22. The process as claimed in claim 20, in which the irrigation is carried out by means of a gravity irrigation device or a pressurized irrigation device.
